(19) United States
(12) Patent Application Publication
(10) Pub. No.: US 2020/0290739 A1
(43) Pub. Date: Sep. 17, 2020

(54) METHOD AND DEVICE FOR MEASURING SPRAY AREA

(71) Applicant: SZ DJI TECHNOLOGY CO., LTD., Shenzhen (CN)

(72) Inventor: Yi ZHOU, Shenzhen (CN)

(21) Appl. No.: 16/890,691

(22) Filed: Jun. 2, 2020

Related U.S. Application Data
(63) Continuation of application No. PCT/CN2017/117035, filed on Dec. 18, 2017.

(51) Int. Cl. B64D 1/18; G05D 1/00; A01M 7/00

(52) U.S. Cl. CPC B64D 1/18; G05D 1/0094; B64C 2201/12; B64C 2201/14; A01M 7/0089

(57) ABSTRACT

A method and a device for measuring a spray area are provided. The method includes obtaining flight data of an unmanned aerial vehicle when performing a spray operation. The method also includes according to the flight data and a spray amplitude of a spray nozzle on the unmanned aerial vehicle for spraying, determining the spray area of the spray operation.

### CROSS-REFERENCE TO RELATED APPLICATION

This application is a continuation of International Application No. PCT/CN2017/117035, filed on Dec. 18, 2017, the entirety of which is incorporated herein by reference.

### TECHNICAL FIELD

The present disclosure generally relates to the field of unmanned aerial vehicle technology and, more particularly, relates to a method and a device for measuring spray area.

### BACKGROUND

With the increasing popularity of consumer-level unmanned aerial vehicles, industry-level unmanned aerial vehicles have also emerged. For the agricultural industry, an agricultural unmanned aerial vehicle, as an industry-level unmanned aerial vehicle, occupies an important position. The agricultural unmanned aerial vehicles can perform plant protection operations, e.g., arable land, spraying pesticides and harvesting crops, etc., on farmland, and have brought great benefits, e.g., saving user time, improving operating efficiency, increasing operating income, and improving the efficiency of agricultural machinery, etc., to the agricultural field. Further, the operations of the agricultural unmanned aerial vehicles can be measured by the workload of plant protection operations, and the operation area is one of the most important and intuitive parameters.

In an existing method, the operation area is often estimated or measured manually before performing the plant protection operation. However, the actual operation is affected by various factors, and the actual operation area is significantly different from the estimated or measured operation area, causing the plant protection workload to be inaccurate. The disclosed method and device for measuring spray area are directed to solve one or more problems set forth above and other problems.

### SUMMARY

One aspect of the present disclosure provides a method for measuring spray area. The method includes obtaining flight data of an unmanned aerial vehicle when performing a spray operation. The method also includes according to the flight data and a spray amplitude of a spray nozzle on the unmanned aerial vehicle for spraying, determining the spray area of the spray operation.

Another aspect of the present disclosure provides a device for measuring spray area. The device includes a memory and a processor. The memory is configured to store a program code. The processor is configured to call the program code, and when the program code being executed, is configured to obtain flight data of an unmanned aerial vehicle when performing a spray operation, and according to the flight data and a spray amplitude of a spray nozzle on the unmanned aerial vehicle for spraying, determine the spray area of the spray operation.

Other aspects of the present disclosure can be understood by those skilled in the art in light of the description, the claims, and the drawings of the present disclosure.

### BRIEF DESCRIPTION OF THE DRAWINGS

To more clearly illustrate the embodiments of the present disclosure, the drawings will be briefly described below. The drawings in the following description are certain embodiments of the present disclosure, and other drawings may be obtained by a person of ordinary skill in the art in view of the drawings provided without creative efforts.

FIG. 1 illustrates a schematic architecture diagram of an exemplary agricultural unmanned aerial vehicle consistent with disclosed embodiments of the present disclosure;

FIG. 2 illustrates a schematic flowchart of an exemplary method for measuring spray area consistent with disclosed embodiments of the present disclosure;

FIG. 3 illustrates a schematic flowchart of another exemplary method for measuring spray area consistent with disclosed embodiments of the present disclosure;

FIG. 4 illustrates a schematic diagram for measuring spray area in FIG. 3 consistent with disclosed embodiments of the present disclosure;

FIG. 5 illustrates a schematic flowchart of another exemplary method for measuring spray area consistent with disclosed embodiments of the present disclosure;

FIG. 6 illustrates a schematic diagram for measuring spray area in FIG. 5 consistent with disclosed embodiments of the present disclosure;

FIG. 7 illustrates a schematic structural diagram of an exemplary device for measuring spray area consistent with disclosed embodiments of the present disclosure;

FIG. 8 illustrates a schematic structural diagram of an exemplary system for measuring spray area consistent with disclosed embodiments of the present disclosure; and

FIG. 9 illustrates a schematic structural diagram of another exemplary system for measuring spray area consistent with disclosed embodiments of the present disclosure.

### DETAILED DESCRIPTION OF THE DISCLOSURE

Reference will now be made in detail to exemplary embodiments of the disclosure, which are illustrated in the accompanying drawings. Wherever possible, the same reference numbers will be used throughout the drawings to refer to the same or the alike parts. The described embodiments are some but not all of the embodiments of the present disclosure. Based on the disclosed embodiments, persons of ordinary skill in the art may derive other embodiments consistent with the present disclosure, all of which are within the scope of the present disclosure.

Similar reference numbers and letters represent similar terms in the following Figures, such that once an item is defined in one Figure, it does not need to be further discussed in subsequent Figures.

The present disclosure provides a method and a device for measuring spray area, which may be applied in the field of unmanned aerial vehicle. The unmanned aerial vehicle may be an agricultural unmanned aerial vehicle, e.g., a rotorcraft. In one embodiment, the rotorcraft may be a multi-rotor aircraft propelled by multiple propulsion devices through air, which is not limited by the present disclosure.

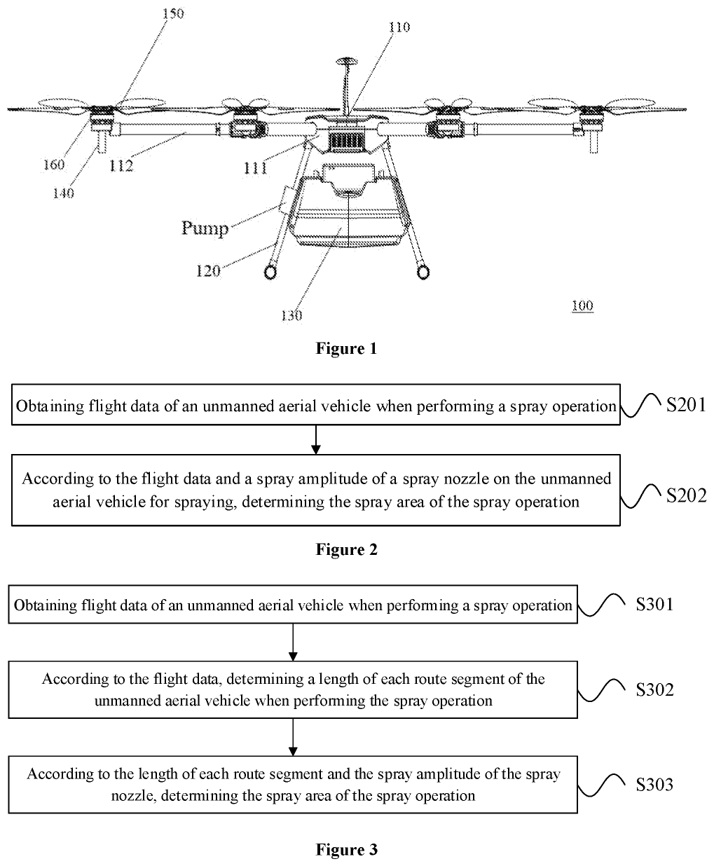

FIG. 1 illustrates a schematic architecture diagram of an agricultural unmanned aerial vehicle consistent with disclosed embodiments of the present disclosure. In one embodiment, for illustrative purposes, an agricultural unmanned aerial vehicle 100 may be a rotor unmanned aerial vehicle.

The agricultural unmanned aerial vehicle 100 may include a power system, a flight control system, and a rack. The agricultural unmanned aerial vehicle 100 may wirelessly communicate with a control terminal. The control terminal may display flight information of the agricultural unmanned aerial vehicle, etc. The control terminal may wirelessly communicate with the agricultural unmanned aerial vehicle 100, and may be configured to remotely control the agricultural unmanned aerial vehicle 100.

The rack may include a fuselage 110 and a tripod 120 (also referred to as a landing gear). The fuselage 110 may include a central frame 111 and one or more arms 112 connected to the central frame 111. The one or more arms 112 may extend radially from the central frame. The tripod 120 may be connected to the fuselage 110, and may be configured for supporting when the agricultural unmanned aerial vehicle 100 is landing. In addition, a liquid storage tank 130 may be mounted in the tripod 120. The liquid storage tank may be configured to store medicinal liquid or water. A spray nozzle 140 may be mounted at an end of an arm 112. The liquid in the liquid storage tank 130 may be pumped into the spray nozzle 140 through a pump, and may be sprayed out by the spray nozzle 140.

The power system may include one or more electronic governors (referred to as ESCs), one or more propellers 150, and one or more motors 160 corresponding to the one or more propellers 150. A motor 160 may connect an electronic governor and a propeller 150. The motor 160 and the propeller 150 may be disposed on the arm 112 of the agricultural unmanned aerial vehicle 100. The electronic governor may be configured to receive a driving signal generated by the flight control system, and may provide a driving current to the motor according to the driving signal to control a rotation speed of the motor 160. The motor 160 may be configured to drive the propeller 150 to rotate, thereby providing power for the flight of the agricultural unmanned aerial vehicle 100. The power may enable the agricultural unmanned aerial vehicle 100 to achieve one or more degrees of freedom of movement. In certain embodiments, the agricultural unmanned aerial vehicle 100 may rotate about one or more rotation axes. In one embodiment, the rotation axis may include a roll axis, a yaw axis, and a pitch axis. The motor 160 may be a direct current (DC) motor or an alternating current (AC) motor. In addition, the motor 160 may be a brushless motor or a brushed motor.

The flight control system may include a flight controller and a sensing system. The sensing system may be configured to measure the attitude information, i.e., the position information and status information of the agricultural unmanned aerial vehicle 100, e.g., three-dimensional position, three-dimensional angle, three-dimensional speed, three-dimensional acceleration, and three-dimensional angular velocity, etc. The sensing system may include at least one of a gyroscope, an ultrasonic sensor, an electronic compass, an inertial measurement unit (IMU), a vision sensor, a global navigation satellite system, or a barometer. In one embodiment, the global navigation satellite system may be a global positioning system (GPS).

The flight controller may be configured to control the flight of the agricultural unmanned aerial vehicle 100. In one embodiment, the flight controller may control the flight of the agricultural unmanned aerial vehicle 100 according to the attitude information measured by the sensing system. The flight controller may control the agricultural unmanned aerial vehicle 100 according to pre-programmed program instructions, and may control the agricultural unmanned aerial vehicle 100 in response to one or more control instructions from the control terminal.

The above-mentioned naming of each component of the agricultural unmanned aerial vehicle may be merely for identification purposes, and may not be limited by the present disclosure.

FIG. 2 illustrates a schematic flowchart of a method for measuring spray area consistent with disclosed embodiments of the present disclosure. Referring to FIG. 2, the disclosed method in the present disclosure may include the following.

S201: obtaining flight data of an unmanned aerial vehicle when performing a spray operation.

S202: determining a spray area of the spray operation according to the flight data and a spray amplitude of a spray nozzle on the unmanned aerial vehicle for spraying.

In one embodiment, the unmanned aerial vehicle may perform the spray operations, e.g., spraying liquid medicine or water, on the farmland. The situation of spray operation may be measured by the determined spray area of the unmanned aerial vehicle. To ensure the effect of the unmanned aerial vehicle performing the spray operation, the unmanned aerial vehicle may often fly in air and may spray liquid onto the ground in air. Therefore, in one embodiment, the flight data of the unmanned aerial vehicle when performing the spray operation may be obtained. In one embodiment, the above-mentioned flight data of the unmanned aerial vehicle may be obtained in real time, or the above-mentioned flight data of the unmanned aerial vehicle may be obtained in real time according to a preset period interval, e.g., 1 second, 2 seconds, 5 seconds, or 10 seconds.

In one embodiment, the flight data may include at least one of flight altitude, flight speed, flight angle, position information, or flight time, which are not limited by the present disclosure. The flight data may reflect the flight conditions (e.g., flight trajectory) of the unmanned aerial vehicle when performing the spray operation. The longer the flight path of the unmanned aerial vehicle when performing the spray operation, the larger the spray area. The shorter the flight path of the unmanned aerial vehicle when performing the spray operation, the smaller the spray area. In addition, the spray area may be related to the spray amplitude of the spray nozzle on the unmanned aerial vehicle for spraying. For a same spray nozzle, the smaller the spray amplitude of the spray nozzle, the smaller the spray area; and the larger the spray amplitude of the spray nozzle, the larger the spray area. Therefore, in the disclosed embodiments, the spray area of the spray operation may be determined according to the flight data and the spray amplitude of the spray nozzle on the unmanned aerial vehicle for spraying.

In the disclosed embodiments, the flight data of the unmanned aerial vehicle when performing the spray operation may be obtained, and the spray area of the spray operation may be determined according to the flight data and the spray amplitude of the spray nozzle on the unmanned aerial vehicle for spraying. Because the flight data reflects the actual flight conditions of the unmanned aerial vehicle, the obtained spray area may be substantially close to the actual spray area of the unmanned aerial vehicle, which may improve the accuracy for measuring the spray area, and may improve the accuracy of the plant protection workload.

In certain embodiments, the spray amplitude of the spray nozzle on the unmanned aerial vehicle for spraying may be obtained. For a different spray operation, the spray nozzle may be provided with a different spray amplitude, or a different spray nozzle may be replaced (a different spray nozzle may have a different spray amplitude). Therefore, to accurately measure the spray area, before determining the spray area, the spray amplitude of the spray nozzle on the unmanned aerial vehicle for spraying may be obtained.

The method in the disclosed embodiments may be applied to the control terminal of an unmanned aerial vehicle, or may be applied to a server. When the disclosed method is applied to the control terminal of an unmanned aerial vehicle, step S201 may include receiving the flight data of the unmanned aerial vehicle when performing the spray operation sent by the unmanned aerial vehicle. In one embodiment, the control terminal may obtain the flight data through a wireless link between the unmanned aerial vehicle and the control terminal.

When the method in the disclosed embodiments is applied to a server, step S201 may include receiving the flight data of the unmanned aerial vehicle when performing the spray operation sent by the unmanned aerial vehicle. In one embodiment, the unmanned aerial vehicle may be configured with a communication interface, and the unmanned aerial vehicle may communicate with the server through the communication interface. The communication interface may be a network communication interface, e.g., a cellular communication interface (3G, 4G, or 5G communication interface). Therefore, the server may receive the above-mentioned flight data sent by the unmanned aerial vehicle through the communication interface.

In another embodiment, step S201 may include receiving the flight data of the unmanned aerial vehicle when performing the spray operation sent by the control terminal of the unmanned aerial vehicle. The control terminal of the unmanned aerial vehicle may be configured with a communication interface, and the control terminal may communicate with the server through the communication interface. The communication interface may be a network communication interface, e.g., a cellular communication interface (3G, 4G, or 5G communication interface). The control terminal of the unmanned aerial vehicle may obtain the above-mentioned flight data through a wireless link between the unmanned aerial vehicle and the control terminal, and then the server may obtain the above-mentioned flight data of the unmanned aerial vehicle sent by the control terminal through the communication interface.

On the basis of FIG. 2, FIG. 3 illustrates a schematic flowchart of another method for measuring spray area consistent with disclosed embodiments of the present disclosure. Referring to FIG. 3, the method in the present disclosure may include the following.

S301: obtaining the flight data of the unmanned aerial vehicle when performing the spray operation. In one embodiment, the detailed implementation of S301 may refer to related descriptions associated with FIG. 2, which is not repeated herein.

S302: determining a length of each route segment of the unmanned aerial vehicle when performing the spray operation according to the flight data.

S303: determining the spray area of the spray operation according to the length of each route segment and the spray amplitude of the spray nozzle on the unmanned aerial vehicle for spraying.

In one embodiment, the step S202 may include the foregoing steps S302 and S303. In one embodiment, after obtaining the flight data of the unmanned aerial vehicle when performing the spray operation, the length of each route segment of the unmanned aerial vehicle when performing the spray operation may be determined according to the flight data. In one embodiment, the length of the route segment may be a spherical distance of projected route segment onto earth surface, and the spherical distance of projected route segment onto the earth surface may be determined according to the position information of the unmanned aerial vehicle in the flight data, which is not limited by the present disclosure.

In certain embodiments, the route segment may be divided at a preset period interval. The flight data may include the flight position and flight time. In one embodiment, the flight position may be the latitude and longitude where the unmanned aerial vehicle is located. In one embodiment, the preset period interval may be 2 seconds, and the length of a route segment may be obtained according to the flight position corresponding to the flight time at a period of 2 seconds. For illustrative purposes, the flight position corresponding to time t1 and the flight position corresponding to time t1+2 seconds may be determined, the distance between the two flight positions may be determined according to the latitude and longitude of the two flight positions, and the distance may be the length of the route segment. Then, the flight position corresponding to time t1+2 seconds and the flight position corresponding to time t1+4 seconds may be determined, the distance between the two flight positions may be determined according to the latitude and longitude of the two flight positions, and the distance may be the length of the route segment. Similarly, the length of entire route segments may be determined.

In certain embodiments, the route segment may be divided at a preset distance interval. The flight data may include the flight position. In one embodiment, the flight position may be latitude and longitude of the unmanned aerial vehicle. In one embodiment, the preset distance interval may be approximately 2 m. In one embodiment, a flight position may be determined, and then another flight position having a distance of approximately 2 m from the flight position may be determined. The two flight positions may determine a route segment, and the length of the route segment may be approximately 2 m. For illustrative purposes, a first flight position and a second flight position 2 m away from the first flight position may be determined from flight positions, and a route from the first flight position to the second flight position may refer to as a route segment. A third flight position 2 m away from the second flight position may be determined from route segments, and a route from the second flight position to the third flight position may refer to as another route segment. Similarly, entire route segments may be determined, and each route segment may have a length of approximately 2 m.

In one embodiment, after obtaining the length of each route segment according to the flight data, because each route segment is a route segment of the unmanned aerial vehicle when performing the spray operation, and the spray amplitude of the spray nozzle on the unmanned aerial vehicle for spraying is known, the spray area of the spray operation may be determined according to the length of each route segment and the spray amplitude of the spray nozzle.

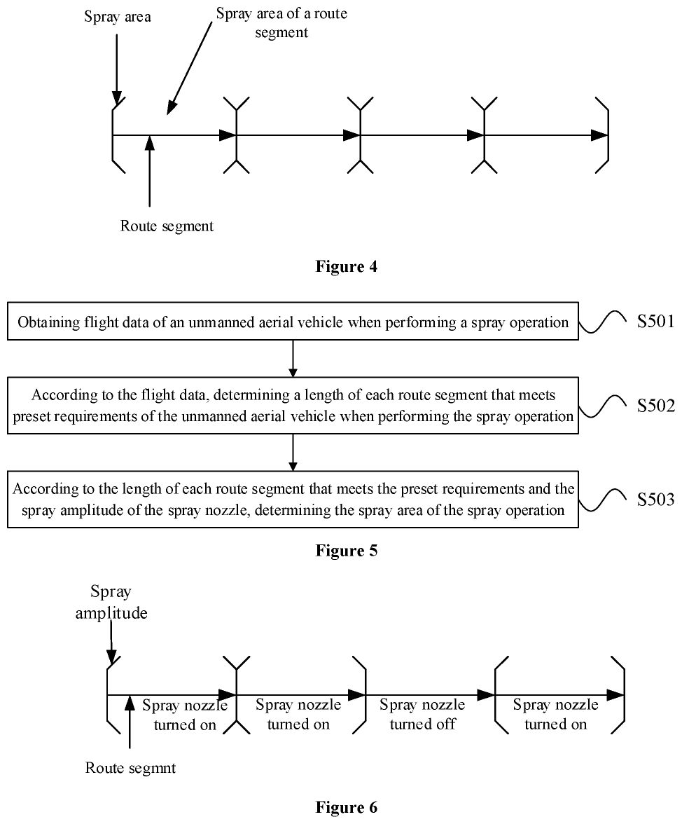

The step S303 may include the following. In one embodiments, S303 may include determining the spray area of a corresponding route segment according to the length of each route segment and the spray amplitude of the spray nozzle; and then determining the spray area of the spray operation according to the spray area corresponding to each route segment. In one embodiment, referring to FIG. 4, the spray area of the unmanned aerial vehicle when flying each route segment to perform the spray operation may be calculated, and then the spray area of the spray operation of the unmanned aerial vehicle may be calculated according to the spray area corresponding to each route segment. In one embodiment, the spray area of the spray operation of the unmanned aerial vehicle may be obtained by summing the spray area corresponding to each route segment.

Determining the spray area of the corresponding route segment according to the length of each route segment and the spray amplitude of the spray nozzle may include the following.

In one embodiment, when the unmanned aerial vehicle flies entire route segments, a quantity of turned-on spray nozzles disposed on the unmanned aerial vehicle may be the same. In another embodiment, entire spray nozzles disposed on the unmanned aerial vehicle may be turned on, such that for each route segment, the spray amplitude of the unmanned aerial vehicle may be the same. The spray amplitude of the unmanned aerial vehicle may be determined according to the spray amplitude of the spray nozzle. In one embodiment, the spray amplitude of the unmanned aerial vehicle may be a product of the quantity of the turned-on spray nozzles and the spray amplitude of the spray nozzle. In view of this, the spray area corresponding to each route segment may be obtained by multiplying the length of each route segment and the spray amplitude of the unmanned aerial vehicle.

In another embodiment, the operating state of the spray nozzle of the unmanned aerial vehicle in each route segment may be obtained. The operating state may include turned-on or turned-off. If a spray nozzle is turned-on, the spray nozzle may be spraying, and the spray amplitude of the spray nozzle may be configured to calculate the spray area. If a spray nozzle is turned-off, the spray nozzle may not be spraying, and the spray amplitude of the spray nozzle may not be configured to calculate the spray area. Therefore, the operating state of the spray nozzle may affect the spray area. Thus, in the disclosed embodiments, according to the length of a route segment, the spray amplitude, and the operating state of the spray nozzle in the route segment, the spray area of a corresponding spray route segment may be determined.

In one embodiment, when the operating state of the spray nozzle in a route segment is turned-off, the spray area of the route segment may be 0. When the operating state of the spray nozzle in a route segment is turned-on, the spray amplitude of the unmanned aerial vehicle may be determined according to the spray amplitude of the spray nozzle, and the spray area of the route segment may be determined according to the spray amplitude of the unmanned aerial vehicle and the length of the route segment. In one embodiment, the spray area of the route segment may be a product of the length of the route segment and the spray amplitude of the unmanned aerial vehicle.

In another embodiment, according to the operating state of the spray nozzle in each route segment, a quantity of spray nozzles whose operating states are turned-on in a corresponding route segment may be determined. Then, according to the length of each route segment, the spray amplitude of the spray nozzle, and the quantity of spray nozzles whose operating states are turned-on in the corresponding route segment, the spray area of the corresponding route segment may be determined. Because the quantity of spray nozzles whose operating states are turned-on in certain route segment may be different, the spray amplitude of the unmanned aerial vehicle in the certain route segment may be different. Therefore, the spray area corresponding to the certain route segment may be different. To accurately measure the spray area, when calculating the spray area corresponding to each route segment, the quantity of turned-on spray nozzles may desire to be considered. For any one route segment i, if the quantity of turned-on spray nozzles is Ni, the spray amplitude of the spray nozzle is S (referred to the spray amplitude of one spray nozzle), and the length of the route segment is Li, the spray amplitude of the unmanned aerial vehicle may be Ni * S, and the spray area of the one route segment i may be Ni * S * Li. In certain embodiments, the quantity of turned-on spray nozzles in a route segment may be 0, in the disclosed embodiments, the obtained spray area of the route segment may be 0.

In certain embodiments, S303 may include determining the length of the route according to the length of each route segment; and then determining the spray area of the spray operation according to the length of the route and the spray amplitude of the spray nozzle. In one embodiment, the length of the entire route of the unmanned aerial vehicle when performing the spray operation may be calculated. In one embodiment, the length of entire route may be obtained by summing the length of each route segment. Then, according to the length of the entire route and the spray amplitude of the spray nozzle, the spray area of the spray operation of the unmanned aerial vehicle may be obtained.

In one embodiment, the spray area of the spray operation may be determined according to the length of the route, the spray amplitude of the spray nozzle, and the quantity of the spray nozzles. More than one spray nozzles may be disposed on the unmanned aerial vehicle. In one embodiment, when the unmanned aerial vehicle flies the entire route, the quantity of turned-on spray nozzles disposed on the unmanned aerial vehicle may be the same. In another embodiment, entire spray nozzles disposed on the unmanned aerial vehicle may be turned-on. In view of this, for the entire route, the spray amplitude of the unmanned aerial vehicle, i.e., the product of the quantity of spray nozzles and the spray amplitude of the spray nozzle, may be the same. Therefore, the spray area of the spray operation of the unmanned aerial vehicle may be obtained by multiplying the length of the entire route, the quantity of spray nozzles, and the spray amplitude of the spray nozzle.

In one embodiment, the length of each route segment may be determined according to the flight data of the unmanned aerial vehicle when performing the spray operation, and then the spray area of the spray operation may be determined according to the length of each route segment and the spray amplitude of the spray nozzle on the unmanned aerial vehicle for spraying. Because the entire route is divided into a plurality of route segments, the spray area obtained according to the length of each route segment may be substantially close to the actual spray area of the unmanned aerial vehicle, which may improve the accuracy for measuring the spray area, and improve the accuracy of the plant protection workload.

On the basis of the embodiments associated with FIG. 2, FIG. 5 illustrates a schematic flowchart of another method for measuring spray area consistent with disclosed embodiments of the present disclosure. Referring to FIG. 5, the disclosed method may include the following.

S501: obtaining flight data of an unmanned aerial vehicle when performing a spray operation. In the disclosed embodiments, the detailed implementation of S501 may refer to related descriptions associated with FIG. 2, which is not repeated herein.

S502: according to the flight data, determining a length of each route segment that meets the preset requirements of the unmanned aerial vehicle when performing the spray operation.

S503: according to the length of each route segment that meets the preset requirements and the spray amplitude of the spray nozzle, determining the spray area of the spray operation.

In one embodiment, the step S202 may include the foregoing steps S502 and S503. In one embodiment, after obtaining the flight data of the unmanned aerial vehicle when performing the spray operation, the length of each route segment that meets the preset requirements of the unmanned aerial vehicle when performing the spray operation may be determined according to the flight data.

The difference between the present embodiment and the embodiment associated with FIG. 3 may include the following. In the embodiment associated with FIG. 3, the length of each route segment of the unmanned aerial vehicle when performing the spray operation may be obtained. In the present embodiment, instead of obtaining the length of each route segment of the unmanned aerial vehicle when performing the spray operation, the length of each route segment that meets the preset requirements may be obtained. If a route segment does not meet the preset requirements, in the present embodiment, the length of the route segment may not be obtained. In other words, when the unmanned aerial vehicle performs the spray operation, certain route segment, where the spray nozzle is not turned on or the unmanned aerial vehicle is flying in an invalid plant protection area (such area may not desire spraying), may not affect the spray area. Therefore, not each route segment may affect the spray area. In the present embodiment, the route segment that meet the preset requirements may be determined from entire route segments of the unmanned aerial vehicle when performing the spray operation, and the length of each route segment that meets the preset requirements may be obtained. In one embodiment, the length of the route segment may be a spherical distance of projected route segment onto earth surface, which is not limited by the present disclosure. The division of the route segment may refer to related descriptions in the above-disclosed embodiments, which is not repeated herein.

In one embodiment, after obtaining the length of each route segment that meets the preset requirements according to the flight data, because each route segment that meets the preset requirements is a route segment that affects the spray area of the spray operation of the unmanned aerial vehicle when performing the spray operation, and the spray amplitude of the spray nozzle on the unmanned aerial vehicle for spraying is known, the spray area of the spray operation may be determined according to the length of each route segment that meets the preset requirements and the spray amplitude of the spray nozzle.

In certain embodiments, before performing S502, the operating state of the spray nozzle in each route segment of the unmanned aerial vehicle when performing the spray operation may be obtained. The operating state may be turned-on or turned-off. If the spray nozzle in a route segment is turned-on, the spray nozzle may be spraying, and the spray amplitude of the spray nozzle may be configured to calculate the spray area. If the spray nozzle is turned-off, the spray nozzle may not be spraying, and the spray amplitude of the spray nozzle may not be configured to calculate the spray area. Therefore, the operating state of the spray nozzle may affect the spray area, such that in the disclosed embodiments, the route segment that meets the preset requirements may be the spray route segment, and the route segment that does not meet the preset requirements may refer to as non-spray route segment. The spray route segment may be a route segment in which the operating state of the spray nozzle is turned-on.

Therefore, performing the steps S502 and S503 may include determining a length of each spray route segment among the route segments according to the flight data and the operating state of the spray nozzle, and then according to the length of each spray route segment and the spray amplitude of the spray nozzle, determining the spray area of the spray operation. In the disclosed embodiments, the spray area may be determined according to the length of the spray route segment, such that the obtained spray area may be substantially close to the area where the unmanned aerial vehicle actually sprays the medicinal solution or water into the plant protection area when performing the spray operation, which may improve the accuracy for measuring the spray area.

According to the length of each spray route segment and the spray amplitude of the spray nozzle, determining the spray area of the corresponding route segment may include the following.

In certain embodiments, according to the length of each spray route segment and the spray amplitude of the spray nozzle, determining the spray area of the spray operation may include: according to the length of each spray route segment and the spray amplitude of the spray nozzle, determining the spray area of the corresponding spray route segment; and then according to the spray area corresponding to each spray route segment, determining the spray area of the spray operation.

In one embodiment, referring to FIG. 6, for illustrative purposes, four route segments may be illustrated. The spray nozzles in a first route segment, a second route segment, and a fourth route segment may be turned-on, and these three route segments may be spray route segment. The spray nozzles in the third route segment may be turned-off, and the third route segment may not be used to calculate the spray area. In one embodiment, the spray area of the unmanned aerial vehicle when flying each spray route segment to perform the spray operation may be calculated, and then the spray area of spray operation of the unmanned aerial vehicle may be calculated according to the obtained spray area corresponding to each spray route segment. In one embodiment, the spray area of the spray operation of the unmanned aerial vehicle may be obtained by summing the spray area corresponding to each spray route segment.

According to the length of each spray route segment and the spray amplitude of the spray nozzle, determining the spray area of the corresponding spray route segment may include the following.

In one embodiment, when the unmanned aerial vehicle flies the spray route segment, the quantity of turned-on spray nozzles disposed on the unmanned aerial vehicle may be the same. In another embodiment, entire spray nozzles disposed on the unmanned aerial vehicle may be turned-on, such that for each spray route segment, the spray amplitude of the unmanned aerial vehicle, i.e., the product of the quantity of the turned-on spray nozzles and the spray amplitude of the spray nozzle, may be the same. In view of this, the spray area corresponding to each spray route segment may be obtained by multiplying the length of each spray route segment and a same spray amplitude.

In another embodiment, because the quantity of the spray nozzles whose operating states are turned-on in each route segment is different, the spray area corresponding to each route segment may be different. To accurately measure the spray area, when calculating the spray area corresponding to each route segment, the quantity of turned-on spray nozzles may desire to be considered. In the disclosed embodiments, according to the operating state of the spray nozzle in each spray route segment, the quantity of the spray nozzles whose operating states are turned-on in the corresponding spray route segment may be determined. The larger the quantity of the spray nozzles whose operating states are turned-on, the larger the spray area. The smaller the quantity of the spray nozzles whose operating states are turned-on, the smaller the spray area. Therefore, the quantity of the spray nozzles whose operating states are turned-on may affect the spray area.

In the disclosed embodiments, according to the length of each spray route segment, the spray amplitude of the spray nozzle, and the quantity of the spray nozzles whose operating states are turned-on in the spray route segment, the spray area corresponding to the spray route segment may be determined. For any one spray route segments i, if the quantity of turned-on spray nozzles is Ni, the spray amplitude of the spray nozzle is S (referred to as the spray amplitude of one spray nozzle), and the length of the spray route segment is Li, the spray amplitude of the unmanned aerial vehicle may be Ni * S, and the spray area of the spray route segment may be Ni * S * Li. Because one or more spray nozzles in the spray route segment are turned-on, the spray area of each spray route segment may be greater than zero.

In certain embodiments, according to the length of each spray route segment and the spray amplitude of the spray nozzle, determining the spray area of the spray operation may include: determining the length of the spray route according to the length of each spray route segment; and then determining the spray area of the spray operation according to the length of the spray route and the spray amplitude of the spray nozzle. In the disclosed embodiments, when the unmanned aerial vehicle performs the spray operation, the length of the spray route may be calculated. The spray route may refer to a route where the spray nozzle disposed on the unmanned aerial vehicle is turned-on. In one embodiment, the length of the entire spray route may be obtained by summing the length of each spray route segment. Then, according to the length of the entire spray route and the spray amplitude of the spray nozzle, the spray area of the spray operation of the unmanned aerial vehicle may be obtained.

In one embodiment, determining the spray area may include determining the spray area of the spray operation according to the length of the spray route, the spray amplitude of the spray nozzle, and the quantity of spray nozzles. Further, more than one spray nozzles may be disposed on the unmanned aerial vehicle. When the unmanned aerial vehicle flies the entire spray route, the quantity of turned-on nozzles disposed on the unmanned aerial vehicle may be the same. In another embodiment, entire spray nozzles disposed on the unmanned aerial vehicle may be turned-on, such that for entire spray route, the spray amplitude of the unmanned aerial vehicle, i.e., the product of the quantity of the spray nozzles and the spray amplitude of the spray nozzle, may be the same. In view of this, the spray area of the spray operation of the unmanned aerial vehicle may be obtained by multiplying the length of entire spray route, the quantity of spray nozzles, and the spray amplitude of the spray nozzle.

In certain embodiments, on the basis of the above-disclosed embodiments, a start operation indicator may be received. The start operation indicator may include a spray operation identification number. The spray operation identification number may be generated when the unmanned aerial vehicle starts to perform the spray operation, and the spray operation identification number may be configured to indicate the spray operation. Therefore, in the disclosed embodiments, after receiving the start operation indicator, the obtained flight data of the unmanned aerial vehicle when performing the spray operation may be the flight data of the spray operation indicated by the spray operation identification number. In other words, the obtained flight data may belong to a same spray operation. In addition, the start operation indicator may be configured to instruct to start measuring the spray area. After receiving the start operation indicator, the spray area may be measured according to the obtained flight data. In view of this, the spray area obtained according to the flight data may be the spray area of the spray operation (i.e., a same spray operation) indicated by the spray operation identification number. In the disclosed embodiments, a spray area of a different spray operation may be distinguished by the spray operation identification number.

In certain embodiments, when performing the spray operation, the unmanned aerial vehicle may suspend the spray operation due to factors such as dosing, charging, etc. Therefore, in the disclosed embodiments, a suspended operation indicator may be received. The suspended operation indicator may be configured to instruct to suspend obtaining the flight data and determining the spray area. Therefore, in the disclosed embodiments, after receiving the suspended operation indicator, obtaining the flight data of the unmanned aerial vehicle when performing the spray operation may be suspended, and determining the spray area of the spray operation according to the flight data and the spray amplitude of the spray nozzle on the unmanned aerial vehicle for spraying may be suspended, to ensure the accuracy for measuring the spray area.

In one embodiment, the suspended operation indicator may further include a spray operation identification number. The suspended operation indicator may be configured to indicate that obtaining the flight data in the spray operation process indicated by the spray operation identification number may be suspended, and determining the spray area of the spray operation indicated by the spray operation identification number may be suspended. Correspondingly, in the disclosed embodiments, obtaining the flight data of the unmanned aerial vehicle when performing the spray operation indicated by the spray operation identification number may be suspended, and according to the flight data and the spraying amplitude of the spray nozzle on the unmanned aerial vehicle for spraying, determining the spray area of the spray operation indicated by the spray operation identification number may be suspended. In one embodiment, spray areas of a plurality of spray operations may be simultaneously measured. Through a spray operation identification number included in the suspended operation indicator, determining the spray area of the spray operation indicated by the spray operation identification number may be suspended, and determining the spray area of any other spray operation may not be affected.

In certain embodiments, if the unmanned aerial vehicle continues to perform a spray operation after completing dosing and charging, etc., the unmanned aerial vehicle may identify whether the spray operation is a continued unfinished spray operation. If the spray operation is a continued unfinished spray operation, in the disclosed embodiments, a resume operation indicator may be received. The resume operation indicator may be configured to instruct to continuously obtain the flight data and determine the spray area. Therefore, in the disclosed embodiments, after receiving the resume operation indicator, the flight data of the unmanned aerial vehicle when performing the spray operation may be continuously obtained. Further, according to the flight data and the spray amplitude of the spray nozzle on the unmanned aerial vehicle for spraying, the spray area of the spray operation may be determined, to ensure the accuracy for measuring the spray area.

In one embodiment, the resume operation indicator may further include a spray operation identification number. The resume operation indicator may be configured to instruct to continuously obtain the flight data in the spray operation process indicated by the spray operation identification number, and to continuously determine the spray area of the spray operation indicated by the spray operation identification number. Correspondingly, in the disclosed embodiments, the flight data of the unmanned aerial vehicle when performing the spray operation indicated by the spray operation identification number may be continuously obtained. Further, according to the flight data and the spray amplitude of the spray nozzle on the unmanned aerial vehicle for spraying, the spray area of the spray operation indicated by the spray operation identification number may be continuously determined. In one embodiment, measuring spray areas of a plurality of spray operations may be simultaneously suspended. Through a spray operation identification number included in the resume operation indicator, the spray area of the spray operation indicated by the spray operation identification number may be continuously determined without affecting the suspension of measuring the spray area of any other spray operation.

In one embodiment, when the solution in the above-disclosed embodiments is applied to the control terminal of the unmanned aerial vehicle, the above-mentioned start operation indicator, suspended operation indicator, and resume operation indicator may be sent by the unmanned aerial vehicle to the control terminal.

In one embodiment, when the solution in the above-disclosed embodiments is applied to a server, the above-mentioned start operation indicator, suspended operation indicator, and resume operation indicator may be sent by the unmanned aerial vehicle to the server. In another embodiment, the above-mentioned start operation indicator, suspended operation indicator, and the resume operation indicator may be sent by the unmanned aerial vehicle to the control terminal of the unmanned aerial vehicle, and then forwarded to the server by the control terminal.

The present disclosure further provides a computer storage medium. The computer storage medium may store program instructions. When being performed, the program may include part of or entire steps of the method for measuring the spray area in FIGS. 2-5 and corresponding embodiments thereof.

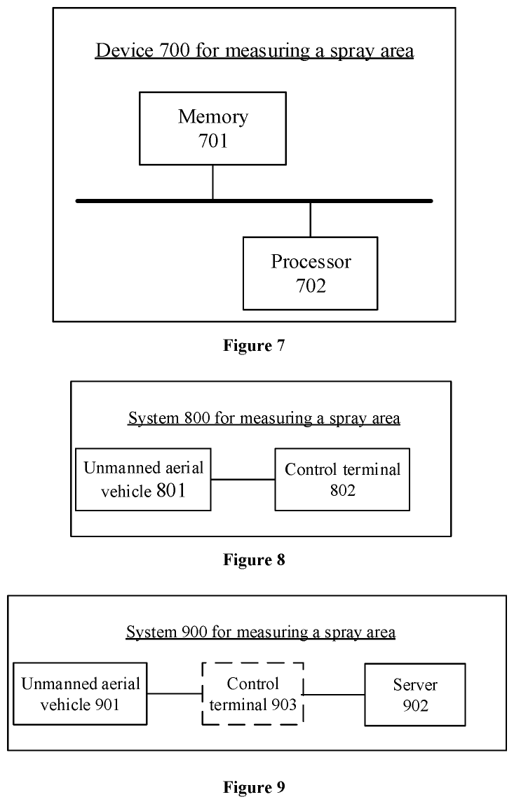

FIG. 7 illustrates a schematic structural diagram of a device for measuring spray area consistent with disclosed embodiments of the present disclosure. Referring to FIG. 7, a device 700 for measuring the spray area may include a memory 701 and a processor 702. The memory 701 and the processor 702 may be connected through a bus. The memory 701 may include a read-only memory and a random access memory, and may provide instructions and data for the processor 702. A part of the memory 701 may further include a non-volatile random access memory.

The processor 702 may be a central processing unit (CPU). In another embodiment, the processor may be a general-purpose processor, a digital signal processor (DSP), an application specific integrated circuit (ASIC), a field-programmable gate array (FPGA), any other programmable logic device, a discrete gate, a transistor logic device, or a discrete hardware component, etc. The general-purpose processor may be a microprocessor, or any conventional processor, etc.

The memory 701 may be configured to store a program code. The processor 702 may be configured to call the program code, and when the program code being executed, may be configured to obtain the flight data of the unmanned aerial vehicle when performing the spray operation; and according to the flight data and the spray amplitude of the spray nozzle on the unmanned aerial vehicle for spraying, determine the spray area of the spray operation. In certain embodiments, the flight data may include at least one of flight altitude, flight speed, flight angle, position information, or flight time.

In certain embodiments, when determining the spray area of the spray operation according to the flight data and the spray amplitude of the spray nozzle on the unmanned aerial vehicle for spraying, the processor 702 may be configured to determine a length of each route segment of the unmanned aerial vehicle when performing the spray operation according to the flight data; and determine the spray area of the spray operation according to the length of each route segment and the spray amplitude of the spray nozzle.

In certain embodiments, when determining the spray area of the spray operation according to the length of each route segment and the spray amplitude of the spray nozzle, the processor 702 may be configured to according to the length of each route segment and the spray amplitude of the spray nozzle, determine the spray area of the corresponding route segment; and according to the spray area corresponding to each route segment, determine the spray area of the spray operation.

In certain embodiments, the processor 702 may be configured to obtain an operating state of the spray nozzle disposed on the unmanned aerial vehicle in each route segment.

When determining the spray area of the corresponding route segment according to the length of each route segment and the spray amplitude of the spray nozzle, the processor 702 may be configured to according to the length of each route segment, the spray amplitude, and the operating state of the spray nozzle in the route segment, determine the spray area of the corresponding route segment.

In certain embodiments, when determining the spray area of the corresponding route segment according to the length of each route segment, the spray amplitude, and the operating state of the spray nozzle in the route segment, the processor 702 may be configured to according to the operating state of the spray nozzle in each route segment, determine a quantity of spray nozzles whose operating states are turned-on in the route segment; and according to the length of each route segment, the spray amplitude, and the quantity of spray nozzles whose operating states are turned-on in the route segment, determine the spray area of the corresponding route segment.

In certain embodiments, when determining the spray area of the spray operation according to the flight data and the spray amplitude of the spray nozzle on the unmanned aerial vehicle for spraying, the processor 702 may be configured to: according to the flight data, determine a length of each route segment that meets the preset requirements of the unmanned aerial vehicle when performing the spray operation; and according to the length of each route segment that meets the preset requirements and the spray amplitude of the spray nozzle, determine the spray area of the spray operation.

In certain embodiments, the processor 702 may be configured to obtain an operating state of the spray nozzle in each route segment of the unmanned aerial vehicle when performing the spray operation.

When according to the flight data, determining the length of each route segment that meets the preset requirements of the unmanned aerial vehicle when performing the spray operation, the processor 702 may be configured to according to the flight data and the operating state of the spray nozzle, determine a length of each spray route segment among the route segments. The spray route segment may be a route segment in which the operating state of the spray nozzle is turned-on.

When according to the length of each spray route segment that meets the preset requirements and the spray amplitude of the spray nozzle, determining the spray area of the spray operation, the processor 702 may be configured to according to the length of each spray route segment and the spray amplitude of the spray nozzle, determine the spray area of the spray operation.

In certain embodiments, when determining the spray area of the spray operation according to the length of each spray route segment and the spray amplitude of the spray nozzle, the processor 702 may be configured to: according to the length of each spray route segment and the spray amplitude of the spray nozzle, determine the spray area of a corresponding spray route segment; and according to the spray area corresponding to each spray route segment, determine the spray area of the spray operation.

In certain embodiments, the processor 702 may be configured to according to the operating state of the spray nozzle in each route segment, determine a quantity of spray nozzles whose operating states are turned-on in a corresponding route segment.

When according to the length of each spray route segment and the spray amplitude of the spray nozzle, determining the spray area corresponding to a spray route segment, the processor 702 may be configured to according to the length of each spray route segment, the spray amplitude of the spray nozzle, and the quantity of spray nozzles whose operating states are turned-on in a corresponding spray route segment, determine the spray area of the corresponding route segment.

In certain embodiments, when determining the spray area of the spray operation according to the length of each route segment and the spray amplitude of the spray nozzle, the processor 702 may be configured to: determine the length of the route according to the length of each route segment; and determine the spray area of the spray operation according to the length of the route and the spray amplitude of the spray nozzle.

In certain embodiments, when determining the spray area of the spray operation according to the length of the route and the spray amplitude of the spray nozzle, the processor 702 may be configured to according to the length of the route, the spray amplitude of the spray nozzle and the quantity of spray nozzles, determine the spray area of the spray operation.

In certain embodiments, when determining the spray area of the spray operation according to the length of each route segment and the spray amplitude of the spray nozzle, the processor 702 may be configured to: according to the length of each spray route segment, determine the length of the spray route; and according to the length of the spray route and the spray amplitude of the spray nozzle, determine the spray area of the spray operation.

In certain embodiments, when determining the spray area of the spray operation according to the length of the spray route and the spray amplitude of the spray nozzle, the processor 702 may be configured to according to the length of the spray route, the quantity of spray nozzles, and the spray amplitude of the spray nozzles, determine the spray area of the spray operation.

In certain embodiments, when obtaining the flight data of the unmanned aerial vehicle when performing the spray operation, the processor 702 may be configured to: receive the flight date of the unmanned aerial vehicle when performing the spray operation sent by the unmanned aerial vehicle; or receive the flight date of the unmanned aerial vehicle when performing the spray operation sent by the control terminal of the unmanned aerial vehicle.

In certain embodiments, the processor 702 may be configured to obtain the spray amplitude of the spray nozzle on the unmanned aerial vehicle for spraying. In certain embodiments, the length of each route segment may be a spherical distance of projected route segment onto the earth surface. In certain embodiments, the route segments may be divided at a preset period interval or at a preset distance interval.

In certain embodiments, the processor 702 may be configured to receive a start operation indicator. The start operation indicator may include a spray operation identification number. When obtaining the flight data of the unmanned aerial vehicle when performing the spray operation, the processor 702 may be configured to after receiving the start operation indicator, obtain the flight data of the unmanned aerial vehicle when performing the spray operation indicated by the spray operation identification number.

In certain embodiments, the processor 702 may be further configured to receive a suspended operation indicator. After receiving the suspended operation indicator, obtaining the flight data of the unmanned aerial vehicle when performing the spray operation may be suspended, and determining the spray area of the spray operation according to the flight data and the spray amplitude of the spray nozzle on the unmanned aerial vehicle for spraying may be suspended.

In certain embodiments, the suspended operation indicator may include a spray operation identification number. When suspending obtaining the flight data of the unmanned aerial vehicle when performing the spray operation, and suspending determining the spray area of the spray operation according to the flight data and the spray amplitude of the spray nozzle on the unmanned aerial vehicle for spraying, the processor 702 may be configured to suspend obtaining the flight data of the unmanned aerial vehicle when performing the spray operation indicated by the spray operation identification number, and to suspend determining the spray area of the spray operation indicated by the spray operation identification number according to the flight data and the spray amplitude of the spray nozzle on the unmanned aerial vehicle for spraying.

In certain embodiments, the processor 702 may be further configured to receive a resume operation indicator. After receiving the resume operation indicator, the flight data of the unmanned aerial vehicle when performing the spray operation may be continuously obtained, and the spray area of the spray operation according to the flight data and the spray amplitude of the spray nozzle on the unmanned aerial vehicle for spraying may be continuously determined.

In certain embodiments, the resume operation indicator may include a spray operation identification number. When continuously obtaining the flight data of the unmanned aerial vehicle when performing the spray operation, and continuously determining the spray area of the spray operation according to the flight data and the spray amplitude of the spray nozzle on the unmanned aerial vehicle for spraying, the processor 702 may be configured to continuously obtain the flight data of the unmanned aerial vehicle when performing the spray operation indicated by the spray operation identification number, and to continuously determine the spray area of the spray operation indicated by the spray operation identification number according to the flight data and the spray amplitude of the spray nozzle on the unmanned aerial vehicle for spraying.

In certain embodiments, the device 700 for measuring the spray area may be a control terminal of the unmanned aerial vehicle. The control terminal may receive the flight data, the start operation indicator, the suspended operation indicator, and the resume operation indicator, etc., sent by the unmanned aerial vehicle.

In certain embodiments, the device 700 for measuring the spray area may be a server. The server may receive the flight data, the start operation indicator, the suspended operation indicator, and the resume operation indicator, etc., sent by the unmanned aerial vehicle. Alternatively, the server may receive the flight data, the start operation indicator, the suspended operation indicator, and the resume operation indicator, etc., sent by the unmanned aerial vehicle and forwarded by the control terminal.

The device in the disclosed embodiments may be configured to achieve the technical solutions of the disclosed methods. The implementation principles and technical effects are similar, which are not repeated herein.

FIG. 8 illustrates a schematic structural diagram of a system for measuring spray area consistent with disclosed embodiments of the present disclosure. Referring to FIG. 8, the system 800 for measuring spray area may include an unmanned aerial vehicle 801 and a control terminal 802. The control terminal 802 may measure the spray area of the spray operation of the unmanned aerial vehicle 801. The control terminal 802 may adopt the structure in the embodiments associated with FIG. 7. Correspondingly, the control terminal 802 may perform the technical solutions of methods in any embodiment associated with FIGS. 2-5. The implementation principles and technical effects are similar, which are not repeated herein.

FIG. 9 illustrates a schematic structural diagram of another system for measuring spray area consistent with disclosed embodiments of the present disclosure. Referring to FIG. 9, the system 900 for measuring spray area may include an unmanned aerial vehicle 901 and a server 902. The server 902 may measure the spray area of the spray operation of the unmanned aerial vehicle 901. The server 902 may adopt the structure in the embodiments associated with FIG. 7. Correspondingly, the server 902 may perform the technical solutions of methods in any embodiment associated with FIGS. 2-5. The implementation principles and technical effects are similar, which are not repeated herein.

In certain embodiments, the system for measuring spray area may further include a control terminal 903. Data and/or signaling between the unmanned aerial vehicle 901 and the server 902 may be forwarded by the control terminal 903.

In the disclosed method and device for measuring spray area, the flight data of the unmanned aerial vehicle when performing the spray operation may be obtained, and the spray area of the spray operation may be determined according to the flight data and the spray amplitude of the spray nozzle on the unmanned aerial vehicle for spraying. Because the flight data reflects the actual flight conditions of the unmanned aerial vehicle, the obtained spray area may be substantially close to the actual spray area of the unmanned aerial vehicle, which may improve the accuracy for measuring the spray area, and may improve the accuracy of the plant protection workload.

Those skilled in the art can understand that entire or part of the steps for achieving the method in the disclosed embodiments may be completed by a program instruction related hardware. The foregoing program may be stored in a computer-readable storage medium. When being executed, the program may include the steps of the method in the disclosed embodiments. The foregoing storage medium may include a read-only memory (ROM), a random access memory (RAM), a magnetic disk, an optical disk, or any other medium capable of storing program codes.

The above detailed descriptions only illustrate certain exemplary embodiments of the present disclosure, and are not intended to limit the scope of the present disclosure. Those skilled in the art can understand the specification as whole and technical features in the various embodiments can be combined into other embodiments understandable to those persons of ordinary skill in the art. Any equivalent or modification thereof, without departing from the spirit and principle of the present disclosure, falls within the true scope of the present disclosure.

What is claimed is:

1. A method for measuring a spray area, comprising:
obtaining flight data of an unmanned aerial vehicle when performing a spray operation; and
according to the flight data and a spray amplitude of a spray nozzle on the unmanned aerial vehicle for spraying, determining the spray area of the spray operation.

2. The method according to claim 1, wherein:
the flight data includes at least one of a flight altitude, a flight speed, a flight angle, position information, or flight time.

3. The method according to claim 1, wherein according to the flight data and the spray amplitude of the spray nozzle, determining the spray area of the spray operation includes:
according to the flight data, determining a length of each route segment of the unmanned aerial vehicle when performing the spray operation; and
according to the length of each route segment and the spray amplitude of the spray nozzle, determining the spray area of the spray operation.

4. The method according to claim 3, wherein according to the length of each route segment and the spray amplitude of the spray nozzle, determining the spray area of the spray operation includes:
according to the length of each route segment and the spray amplitude of the spray nozzle, determining a spray area of a corresponding route segment; and
according to a spray area corresponding to each route segment, determining the spray area of the spray operation.

5. The method according to claim 3, further including:
obtaining an operating state of the spray nozzle disposed on the unmanned aerial vehicle in each route segment, wherein according to the length of each route segment and the spray amplitude of the spray nozzle, determining the spray area of the corresponding route segment includes:
according to the length of each route segment, the spray amplitude, and the operating state of the spray nozzle in the corresponding route segment, determining the spray area of the corresponding route segment.

6. The method according to claim 5, wherein according to the length of each route segment, the spray amplitude, and the operating state of the spray nozzle in the corresponding route segment, determining the spray area of the corresponding route segment includes:
according to the operating state of the spray nozzle in each route segment, determining a quantity of spray nozzles whose operating states are turned-on in the corresponding route segment; and
according to the length of each route segment, the spray amplitude, and the quantity of the spray nozzles whose operating states are turned-on in the corresponding route segment, determining the spray area of the corresponding route segment.

7. The method according to claim 1, wherein according to the flight data and the spray amplitude of the spray nozzle, determining the spray area of the unmanned aerial vehicle includes:
according to the flight data, determining a length of each route segment that meets preset requirements of the unmanned aerial vehicle when performing the spray operation; and
according to the length of each route segment that meets the preset requirements and the spray amplitude of the spray nozzle, determining the spray area of the spray operation.

8. The method according to claim 7, further including:
obtaining an operating state of the spray nozzle in each route segment of the unmanned aerial vehicle when performing the spray operation, wherein:
according to the flight data, determining the length of each route segment that meets the preset requirements of the unmanned aerial vehicle when performing the spray operation includes:
according to the flight data and the operating state of the spray nozzle, determining a length of each spray route segment among route segments, wherein a spray route segment is a route segment in which the operating state of the spray nozzle is turned-on, and
according to the length of each spray route segment that meets the preset requirements and the spray amplitude of the spray nozzle, determining the spray area of the spray operation includes:
according to the length of each spray route segment and the spray amplitude of the spray nozzle, determining the spray area of the spray operation.

9. The method according to claim 8, wherein according to the length of each spray route segment and the spray amplitude of the spray nozzle, determining the spray area of the spray operation includes:
according to the length of each spray route segment and the spray amplitude of the spray nozzle, determining a spray area of a corresponding spray route segment; and
according to a spray area corresponding to each spray route segment, determining the spray area of the spray operation.

10. The method according to claim 9, further including:
according to the operating state of the spray nozzle in each spray route segment, determining a quantity of spray nozzles whose operating states are turned-on in each spray route segment, wherein according to the length of each spray route segment and the spray amplitude of the spray nozzle, determining the spray area of the corresponding spray route segment includes:
according to the length of each spray route segment, the quantity of the spray nozzles whose operating states are turned-on in the corresponding spray route segment, and the spray amplitude of the spray nozzle, determining the spray area of the corresponding spray route segment.

11. The method according to claim 3, wherein according to the length of each route segment and the spray amplitude of the spray nozzle, determining the spray area of the spray operation includes:
according to the length of each route segment, determining a length of a route; and
according to the length of the route and the spray amplitude of the spray nozzle, determining the spray area of the spray operation.

12. The method according to claim 11, wherein according to the length of the route and the spray amplitude of the spray nozzle, determining the spray area of the spray operation includes:
according to the length of the route, the spray amplitude of the spray nozzle, and a quantity of spray nozzles, determining the spray area of the spray operation.

13. The method according to claim 8, wherein according to the length of each spray route segment and the spray amplitude of the spray nozzle, determining the spray area of the spray operation includes:
according to the length of each spray route segment, determining a length of a spray route; and
according to the length of the spray route and the spray amplitude of the spray nozzle, determining the spray area of the spray operation.

14. The method according to claim 13, wherein according to the length of the spray route and the spray amplitude of the spray nozzle, determining the spray area of the spray operation includes:
according to the length of the spray route, a quantity of spray nozzles, and the spray amplitude of the spray nozzle, determining the spray area of the spray operation.

15. The method according to claim 1, wherein obtaining the flight data of the unmanned aerial vehicle when performing the spray operation includes:
receiving the flight data of the unmanned aerial vehicle when performing the spray operation sent by the unmanned aerial vehicle; or
receiving the flight data of the unmanned aerial vehicle when performing the spray operation sent by a control terminal of the unmanned aerial vehicle.

16. The method according to claim 1, further including:
obtaining the spray amplitude of the spray nozzle on the unmanned aerial vehicle for spraying.

17. The method according to claim 3, wherein:
the length of each route segment is a spherical distance of a projected route segment onto an earth surface.

18. The method according to claim 3, wherein:
the route segment is divided by a preset period interval or by a preset distance interval.

19. A device for measuring a spray area, comprising:
a memory and a processor, wherein:
the memory is configured to store a program code; and
the processor is configured to call the program code, and when the program code being executed, is configured to:
obtain flight data of an unmanned aerial vehicle when performing a spray operation, and
according to the flight data and a spray amplitude of a spray nozzle on the unmanned aerial vehicle for spraying, determine the spray area of the spray operation.

20. The device according to claim 19, wherein when according to the flight data and the spray amplitude of the spray nozzle for determining the spray area of the spray operation, the processor is further configured to:
according to the flight data, determine a length of each route segment of the unmanned aerial vehicle when performing the spray operation; and
according to the length of each route segment and the spray amplitude of the spray nozzle, determine the spray area of the spray operation.
